(19) United States
(12) Patent Application Publication
(10) Pub. No.: US 2011/0265399 A1
(43) Pub. Date: Nov. 3, 2011

(54) Universal block with recessed knock-out panels

(76) Inventor: Kevin Hahn, Vancouver, WA (US)

(21) Appl. No.: 12/799,796

(22) Filed: May 3, 2010

(51) Int. Cl. F21V 33/00; E04C 1/42; E04C 1/00

(52) U.S. Cl. 52/173.1; 52/607; 52/578; 52/306

(57) ABSTRACT

A universal concrete or masonry block with four walls, a hollow center within the four walls, and a recessed knockout panel on each wall. Each recessed knockout panel is half the height of the block and has recessed cutting slots partially through the wall on either side of the recessed panel. The recessed knockout panels may be removed to leave an opening as desired on any or all of the four sides of the block. The opening(s) may be used to support a fence rail, a light or a plant.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT Not Applicable.

### BACKGROUND OF THE INVENTION

1. Field of the Invention

The present invention relates to structural and decorative blocks and particularly to a universal block such as a concrete or masonry block with four walls, a hollow center within the four walls, a recessed knockout panel half the height of the block with cut lines in each wall that can be removed to leave an opening as desired on any or all of the four sides of the block; the opening(s) may be used to support a fence rail or to allow light to emit from the interior of a universal block having a light source mounted inside of it or used to receive planters or for other uses.

2. Description of Related Art Including Information Disclosed Under 37 CFR 1.97 And 1.98

Structural blocks generally have uniformly solid walls which may be stacked in desired arrays for building elements. While some have thinner wall portions called knock out panels which may be knocked out by a hammer, this is generally a rough edged functional opening, such as an opening to receive utilities into or through the structure formed by the blocks. Prior art blocks do not adequately provide for a universal block which may be used in a variety of ways in structural and decorative arrays.

Prior art U.S. Patent Application #20080047219, published Feb. 28, 2008 by Donohew, puts forth molded masonry blocks with at least one pre-formed or easily formed opening for an electrical box without requiring that an opening be cut with a saw or a chisel. One exemplary masonry block has at least one integrally molded opening for receiving an electrical box. Another exemplary masonry block has at least one integrally-molded knock-out that provides a selectably removable opening for receiving an electrical box. The knock-out may be formed of the same material from which the masonry block is molded, and may be, for example, formed with a thinned portion of a wall of the block or a plurality of cuts in a portion of a wall shaped the same as the electrical box opening.

Prior art U.S. Pat. No. 7,174,687, issued Feb. 13, 2007 to Ferguson, is for a dry stack building block for constructing a masonry wall. The dry stack unit has a front section having an outer surface, an inner surface, a bottom surface, and a top surface. The dry stack unit also has a rear section substantially parallel to the front section having an outer surface, an inner surface, a bottom surface, and a top surface. Two or more webs coupling the inner surface of the front section to the inner surface of the rear section have a top surface and a bottom surface. Two or more pairs of lugs may extend above the top surface of the front section and the top surface of the rear section. Each pair of lugs may have a first lug offset from a second lug in an axis perpendicular to the inner surfaces of the front section and the back section.

Prior art U.S. Pat. No. 6,065,265 issued May 23, 2000 to Stenekes, describes an interlocking building block for use in constructing mortarless walls in which the block has a first face shell in spaced relationship with a second face shell which define opposed inner surfaces for the block. Between the face shells, there stands at least one transversely-disposed bridge portion and a transverse end portion which defines an operatively outer surface for the block and which closes one end of the block between the first and second face shells. A grouting cavity is formed between the transverse end portion and a bridge portion. Both the transversely-disposed bridge portions and the transverse end portion have integrally-formed projections which extend above the height of the block on an operatively-upper surface and corresponding recesses are formed in an operatively lower surface of the block. Channels are formed in the opposed inner surfaces of the face shells which are adapted to receive and locate corresponding projections of an underlying interlocking block which is oriented orthogonally to the block, and the channels also define a reduced wall thickness in the first and second face shells which may be partially broken away to receive a reinforcement bar for reinforcing grout which is added to the grouting cavity.

Prior art U.S. Pat. No. 4,671,039, issued Jun. 9, 1987 to Hunt, provides a building block for use in building a structure consisting of linear or stepped courses of a plurality of blocks is designed such that any two types are required, a full block and a half block. Each full or half block consists of a substantially parallel piped body having upper and lower faces, opposed side walls and opposed end walls. The side walls and the end walls define a central cavity and the blocks are arranged to receive similar blocks in overlying and underlying relationship. The outer surfaces of the side walls and end walls each include interlocking means, preferably in the form of fluting, any of which may be inter-engaged with any of the interlocking means of the outer surfaces of another building block of the same type. In a structure the blocks may interlock with a juxtaposed block in side to side, end to end, or end to side disposition.

Prior art U.S. Pat. #16,486, issued Jan. 27, 1857 to Johnson, illustrates a fence post comprised of a series of stackable cementitious blocks. Each block has a notch in one side therein for the purpose of holding a fence rail.

Prior art U.S. Pat. No. 4,703,600, issued Nov. 3, 1987 to Suh, claims vertically assembling a box-type masonry block comprising a quadrangular or H-type concrete block body provided at the interior thereof with a space. The block also includes an engaging step formed at inner upper surface of said block body, an engaging protrusion formed at lower surface of said block body, and a fixing rod-receiving hole formed at each corner of said block body.

Prior art U.S. Patent Application #20060150559, published Jul. 13, 2006 by Haener, shows an interlocking block system consisting of a full block and a half block which are installed mortar free with the internal cells filled with grout as required. The blocks must be laid in the upright position but may be rotated end to end as required for aesthetic reasons or to create an additional square internal cell. The blocks are supported by a tongue and groove engagement at the four external corners and four internal locking members that engage within the block on the course above. Knockout sections and relief areas are supplied for the installation of reinforcing bars. When the blocks are turned at a ninety degree angle to make a corner, the internal locking members engage in the square end cell of the block above equally as well as they do in a straight course of blocks.

Prior art U.S. Patent Application #20070186502, published Aug. 16, 2007 by Marsh et al, provides a concrete masonry unit in FIG. 6 which has a “knock-out” feature on the exterior of the block. When or if a bar is needed to extend past the exterior surface of the concrete masonry unit, the knockout is merely removed by knocking the sidewall out of the block.

Three prior art U.S. Patent Applications, #20080172970 published Jul. 24, 2008 and #20050252146 and #20050252147 published Nov. 17, 2005 by MacDonald et al, concern a system of columnar blocks and stacking blocks interlock with each other in the construction of a pilaster or column and a fence panel, respectively, for use in a fence. The columnar blocks are generally square and the stacking blocks are generally rectangular. The columnar block faces may contain one or more slots to give a column an appearance of a masonry joint. Blocks have at least one interlocking element that permits a positive connection between courses of the blocks when the interlocking element is received in an overlying block.

Prior art U.S. Patent Application #20070193183, published Aug. 23, 2007 by Price et al, is for a concrete block for forming columns. A modular post block may include a core through the block body and three interlocking portions disposed on the inner perimeter surface of each block that project outward from one of the bottom surface or the top surface of each block. First and second interlocking portions are disposed on one surface of the inner perimeter and third interlocking portion is disposed on the opposite side. Blocks can be stacked in a column by horizontally rotating each successive block 180 degrees. Interlocking portions of a first block then project into the core of a second block and the third interlocking portion of the first block fits at least partially between two interlocking portions of the adjacent second block.

Prior art U.S. Pat. No. 4,319,440, issued Mar. 16, 1982 to Rassias et al, shows a corner block in FIGS. 4 and 5, which has half of the block having a square vertical passage surrounded by generally uniform thickness walls. The upper and lower surfaces of each outer wall and inner wall are provided with notches which extend about halfway through the thickness of the wall. By knocking out the balance of the wall thickness at any group of notches it is possible to place the corner block intermediate the ends of a wall to build a pilaster or to carry a soil or drain pipe or the like, or to use it as a corner running in any direction.

Prior art U.S. Pat. No. 4,041,660, issued Aug. 16, 1977 to Yensen, provides a self-aligning construction block with reinforcement slots or recesses that are intentionally molded short of their respective adjacent sides or ends. This thin walled portion or the portion between the slots may be knocked out to allow a through passage.

Prior art U.S. Pat. No. 5,934,035, issued Aug. 10, 1999 to Rasmussen et al, shows a modular pillar which is assembled by overlaying pre-cast brick layers, one on top of the other to form a pillar of such layers. Each layer has a depression, groove, channel, cut-out, or the like, of recessing one of its horizontal surfaces for interlocking mating with a corresponding elevation or protrusion on the adjacent horizontal surface of the next adjacent layer.

Prior art U.S. Pat. No. 5,623,797, issued Apr. 29, 1997 to Gravier et al, describes a block structure and system for arranging above-ground fencing, railing and/or sound barriers. Interlocking stackable block structures are provided for use in erecting a shock-resistant wall array and including block structures in both fence block and post block configurations. The top surface of each of the blocks has a pair of parallelly disposed upwardly protruding laterally extending ridge projections which mate and interlock with projections formed on the bottom surface of the block. The block configuration is further provided with cores for drainage and load reduction purposes, but the upper and lower mating faces of the block have a load-bearing web which supports a superimposed stacked block thereon. The cores of the post block contain a reinforcing rod held in grout so as to provide strength and stability. Also, the post block structures are provided with recesses for lockingly receiving fence block therein, thereby providing an arrangement where the fence block array floats within the recesses and is thereby provided with a greater degree of stability.

Prior art U.S. Pat. No. 5,881,512, issued Mar. 16, 1999 to Chang, concerns a pre-cast wall/column module including a hollow body formed from a four-side outer frame and an inscribed round pipe. The outer frame has an upper end forming a first axially projected flange extending along an inner edge of the upper end and a lowered outer edge extending around the first flange, and a lower end forming a second axially projected flange extending along an outer edge of the lower end and a lowered inner edge extending along an inner side of the second flange. Axially extended insertion holes are correspondingly formed at every corner of the upper and lower ends to receive insertion bars for connecting the modules to one another. A thinned area can be selectively provided on either side of the outer frame. Two semicircular openings are separately formed at upper and lower edges of each thinned area and a plurality of round holes is spaced between the two semicircular openings.

What is needed is a universal cast masonry or concrete block having well delineated recessed wall panels with bordering recessed cutting slots in each wall of the block for cutting out receiving openings having smooth edges for attractive structural and decorative use allowing wide universal applications with any desired elements inserted in the receiving openings which may be formed as desired or needed anywhere in an array of universal blocks, particularly useful in structural and landscaping applications.

### BRIEF SUMMARY OF THE INVENTION

An object of the present invention is to provide a universal cast masonry or concrete block having well delineated recessed wall panels with bordering recessed cutting slots in each wall of the block for cutting out receiving openings having smooth edges for attractive structural and decorative use allowing wide universal applications with any desired elements inserted in the receiving openings which may be formed as desired or needed anywhere in an array of universal blocks, particularly useful in structural and landscaping applications, such as a column or post for receiving railings or lights or plants therein or horizontal lighted arrays for traveled ways such as paths, walks, and driveways.

Another object of the present invention is to provide a vertically stacked array of blocks having a pair of adjacent universal blocks each having a panel removed from an adjacent wall with one of the universal blocks inverted relative to the adjacent universal block to join the two receiving openings together to form a double size receiving opening.

In brief, the present invention comprises a universal block having connected peripheral walls open at the top and bottom surrounding a hollow interior, each of the walls having at least one recessed side panel with cut out lines cast into the block on all sides for cutting out as many side panels as desired to form receiving openings in the block to be used in structural and landscaping arrays with external elements inserted in the receiving openings.

The purpose of the device is to provide a universal masonry or concrete block to be used in structural and landscaping applications, such as a column or post and landscaping arrays, which gives a homeowner or contractor many options for its use. Each wall in the universal block is provided with a recessed knockout panel which a user may choose to remove to create an opening or leave intact based on the structural needs. Each recessed knockout panel is provided with cut out lines formed on either side of the knockout panel which allows a user to cut along said recessed cut out lines with a masonry saw for a clean aesthetic looking opening. The openings in the universal block may be used to support fence railings or receive lights or plants therein. The openings may also receive horizontal lighted arrays for traveled ways such as paths, walks, and driveways.

An advantage of the present invention is that it provides a wide spectrum of structural and landscaping applications.

Another advantage of the present invention is that it provides an easily removable recessed panel.

One more advantage of the present invention is that it provides a clean and aesthetic edge on the knockout opening.

Yet another advantage of the present invention is that it is cost effective.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the universal block of the present invention showing the recessed panel and adjacent recessed cutting slots in each of the walls;

FIG. 2 is a top plan view of the universal block of FIG. 1 showing the recessed panel and adjacent recessed cutting slots in each of the walls;

FIG. 3 is a side elevational view of the universal block of FIG. 1 with the recessed panel and adjacent recessed cutting slots in each of the walls shown dashed;

FIG. 4 is a perspective view of a vertically stacked array of the universal blocks of the present invention forming a corner fence post showing two adjacent cut out panels of one of the universal blocks cut out to form receiving openings for two orthogonal fence rails inserted in the receiving openings;

FIG. 5 is a perspective view of a vertically stacked array of the universal blocks of the present invention forming a middle fence post with a tall rail through a double hole formed by turning the upper block with a hole upside down to mate with the hole in the lower block and also having a light in the receiving opening in the top block with a cap on top of the block;

FIG. 6 is a side elevational view of a vertically stacked array of the universal blocks of the present invention to form column on the left with a beacon type light shining through a double receiving opening in the top pair of blocks formed by turning the top block upside down so the two openings together form a double opening and a string of horizontal blocks with spaced lights in double openings in paired inverted blocks along the edge of a sidewalk or driveway to light the walk or driveway;

FIG. 7 is a perspective view of a vertically stacked array of the universal blocks of the present invention to form a column planter with a plant in the top opening of the top block and plants down the column in single and double openings.

### DETAILED DESCRIPTION OF THE INVENTION

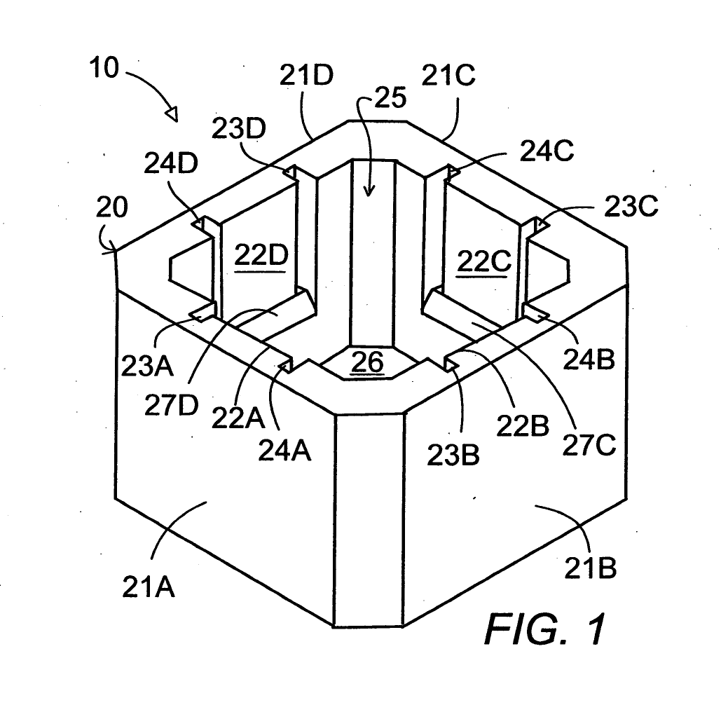

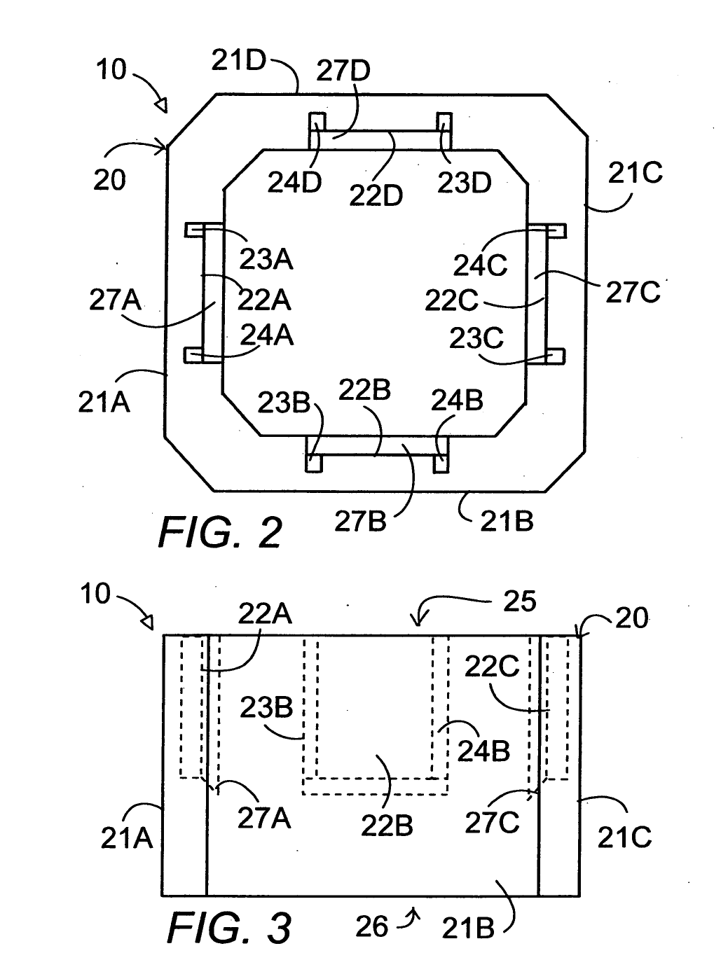

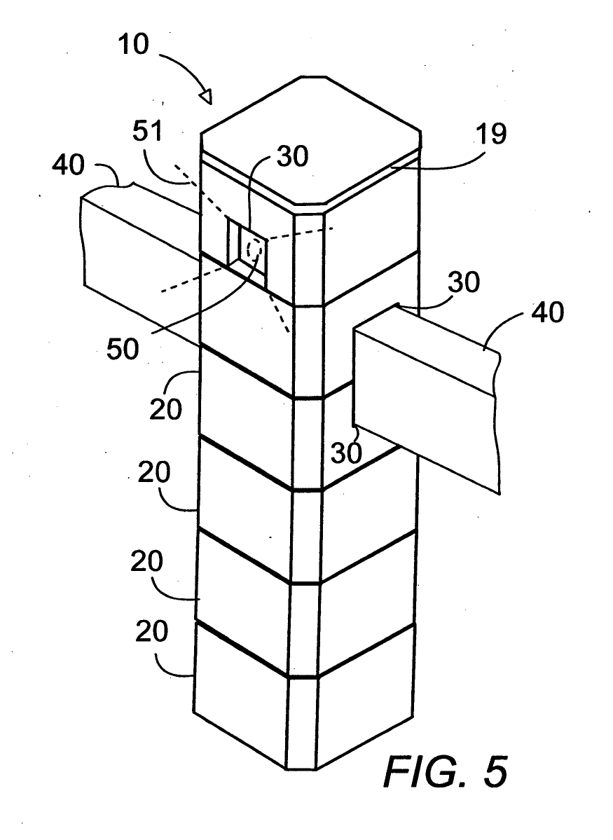

In FIGS. 1-7, a universal block system 10 has knockout panels 22A-22D to form receiving openings 30 in each universal block 20 to be used in structural and landscaping arrays with external elements 40, 50 and 60 inserted in the receiving openings 30, as shown in FIGS. 4-7.

The universal block system 10 comprises a series of universal blocks 20, each universal block 20 comprising a configuration of interconnected walls 21A-21D forming a continuous perimeter around a hollow center 25 and 26.

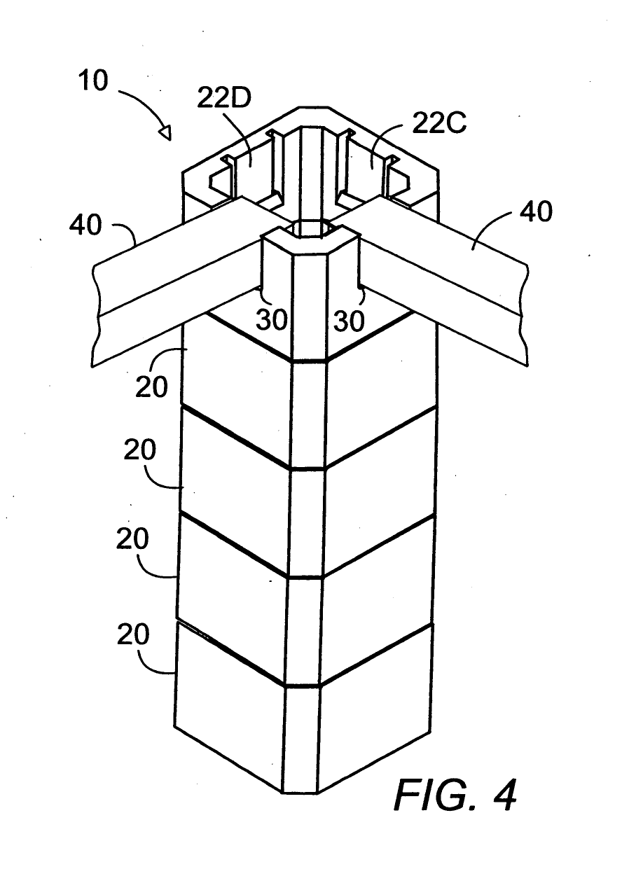

The interconnected walls 21A-21D have a continuous shared top edge defining a top opening 25 and a continuous shared bottom edge defining a bottom opening 26, as shown in FIGS. 1 and 3. A top edge of one universal block 20 mates with and aligns with a bottom edge of an adjacent universal block 20 in an array, as shown in FIG. 4. A knockout panel 22A-22D is cast into each of the walls 21A-21D extending from an edge of the wall to a tapered portion 27A-27D on an interior face of the wall 21A-21D. Each knockout panel 22A-22D comprises an internally recessed wall portion 22A-22D of the wall 21A-21D and a recessed cutting slot 23A-23D and 24A-24D on each side of the internally recessed wall portion 22A-22D for cutting through the wall 21A-21D in the recessed cutting slots 23A-23D and 24A-24D to remove the knockout panel 22A-22D leaving a receiving opening 30 in the wall 21A-21D. When the knockout panel 22A-22D is removed, the receiving opening 30 has finished edges extending transversely through the wall 21A-21D along a portion of the height of the wall 21A-21D for inserting any of a variety of desired items 40, 50 and 60 within the receiving opening 30.

Each of the universal blocks 20 has four flat orthogonal walls 21A-21D and flat edges perpendicular to the walls 21A-21D so that the universal blocks 20 are stackable in any desired array, as shown in FIGS. 4-7. Each universal block 20 comprises a cast masonry block 20 and a smooth edged receiving opening 30 formed in each wall 21A-21D with the panel 22A-22D cut out with a masonry saw (not shown) along the recessed cutting slots 23A-23D and 24A-24D on one or all sides 21A-21d of an array of blocks 10. The openings 30 are produced by using a masonry saw blade in the preset cutting lines 23A-23D and 24A-24D to remove as many of the knock out panels 22A-22D as desired.

In FIGS. 4 and 5, the universal blocks 20 are stacked in a series of spaced vertical arrays 10 and one or more of the panels 22A-22D are removed from a universal block 20 to form one or more receiving openings 30 in a first vertical array 10 to align with a mating aligned receiving opening 30 in a second vertical array (not shown) to receive a horizontal fence rail 40 therebetween in the receiving openings 30 so that the spaced vertical arrays 10 of universal blocks 20 form fence posts 10, as shown in FIGS. 4 and 5. The system 10 may further comprise a cap 19 over a top universal block 20 in an array 10, as shown in FIG. 5.

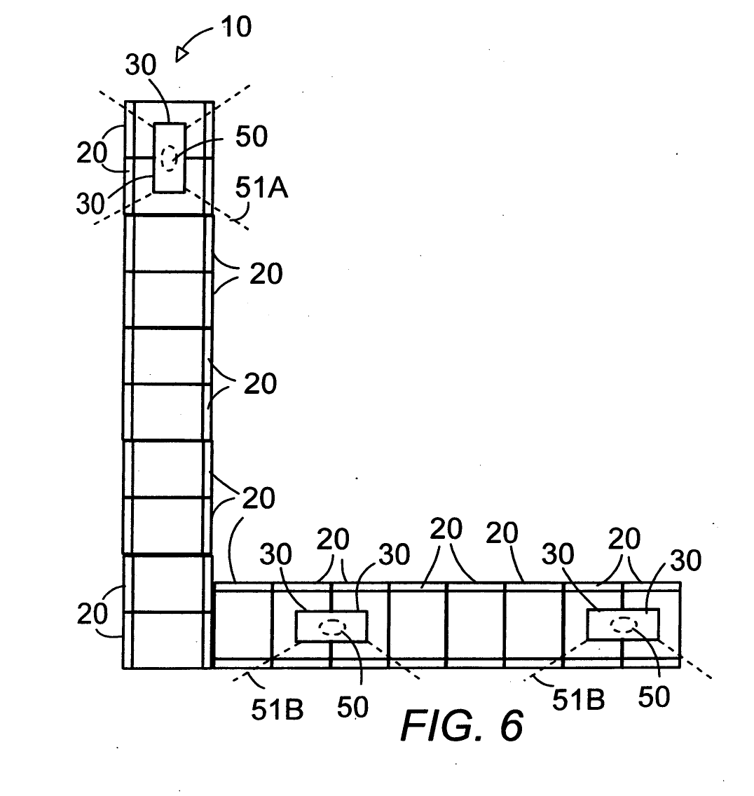

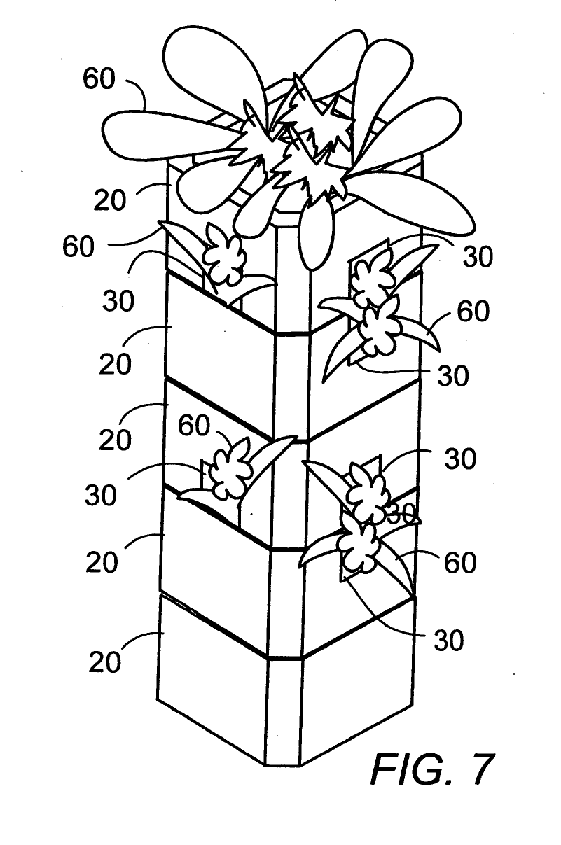

The vertically stacked array 10 of the universal blocks 20 may also comprise a corner fence post 10 having two adjacent cut out panels 22A-22D of one of the universal blocks 20 cut out to form receiving openings 30 for two orthogonal fence rails 40 inserted with one fence rail 40 in each of the receiving openings 30, as shown in FIG. 4. The array of universal blocks 10 may also comprise a pair of adjacent universal blocks 20 each having a panel 22A-22D removed from an adjacent wall 21A-21D having one of the universal blocks 20 inverted relative to the adjacent universal block 20 to join the two receiving openings 30 together to form a double size receiving opening 30, as shown in FIGS. 5 and 6 and on the right side of the planter in FIG. 7.

The universal block system 10 may further comprise a vertically stacked array of blocks 20 having a pair of adjacent universal blocks 20 each having a panel 22-22D removed from an adjacent wall 21A-21D with one of the universal blocks 20 inverted relative to the adjacent universal block 20 to join the two receiving openings 30 together to form a double size receiving opening 30 for receiving a wide fence rail 40 through the double size receiving openings 30, as shown in FIG. 5.

The system 10 may also comprise an array of universal blocks 20 wherein one or more of the universal blocks 20 has one or more panels 22A-22D removed to create a receiving opening 30 for inserting a light source 50 therein, as shown in FIGS. 5 and 6. The system 10 may further comprise a translucent glass block (not shown) inserted in the receiving opening 30 for admitting light rays 51, 51A and 51B out of the receiving opening 30 through the glass block. The universal blocks 20 may be assembled in a vertical array to form a light post 10, as shown in FIG. 5 and by the column 10 on the left side of FIG. 6. Alternately, the universal blocks 20 may be assembled in a horizontal array, as shown on the bottom of FIG. 6, to line a travel way, such as a path, sidewalk, driveway, or other traveled way which would benefit from edge definition and night lighting. In this horizontal arrangement a number of the universal blocks 20 have receiving openings 30 with light sources 50 therein for illuminating the travel way with a horizontal light pattern 51B.

In FIG. 7, the system 10 may also comprise a vertically stacked array of the universal blocks 20 to form a column planter with a plant 60 in the top opening 25 of the top block 20 and a plurality of plants 60 down the column in single receiving openings 30 in a number of the universal blocks 20, as shown on the left side of the planter 10 in FIG. 7. Plants 60 may also be placed in double receiving openings 30 formed by a pair of adjacent universal blocks 20 each having a panel 22A-22D removed from an adjacent wall 21A-21D having one of the universal blocks 20 inverted relative to the adjacent universal block 20 to join the two receiving openings 30 together to form a double receiving opening 30, as shown on the right side of the column in FIG. 7.

In use, the universal block 20 of the present invention 10 may comprise a concrete landscaping block 20 which may be stacked vertically to form a series of fence posts 10 with the fence railings 40 inserted in the openings 30. Opposing recessed panels 22A and 22C or 22B and 22D may be removed to accommodate railings 40 a series of fence posts 10 in a straight row (not shown). Adjacent recessed panels 22A-22D may be removed to create a corner fence post 10, as shown in FIG. 4. Fence rails 40 may be equal to the height of one opening 30, as shown in FIG. 4 or a double opening 30 with a pair of blocks 20 stacked vertically to align a top opening 30 in a bottom block 20 with a bottom opening 30 in an adjacent top block 20, as shown in FIG. 5.

The universal blocks 20 may be stacked vertically to form a column or post 10 with a series of lights 50 in a series of openings 30 along one or more sides of the post 10 or just a single light 50 in a top opening 30 casting beacon type rays of light 51, as shown in FIG. 5. Any block 20 may have just one opening 30 or may have double, triple, or quadruple openings 30 to cast light 51 in one direction or multiple directions. Glass inserts or blocks (not shown) may be used to cover the openings 30 with the light 50 inside to shine through the glass insert in the opening 30. The blocks 20 may be stacked in any desired array including walls (not shown) or a single horizontal array along an edge of a walk or driveway, as shown at the bottom of FIG. 6, and supplied with lights 50 in the openings 30. In the horizontal array, horizontally oriented light 51B is distributed for better illumination of the travel path. In a vertical arrangement, such as shown by the column 10 on the left side of FIG. 6, a light 50 may be used which distributes a vertically oriented light 51A. Colored lights 50 may be used for ornamental purposes. Solar collectors (not shown) can be incorporated in any array of lighted blocks 20.

The universal blocks 20 may be stacked vertically with vertically aligned center openings 25 and 26 to form an agricultural planter block 20, as shown in FIG. 7, with plantings 60 in one or more openings 30 and a flow down irrigation system (not shown). The openings 30 may be single receiving openings 30 in a number of the universal blocks 20, as shown on the left side of the planter 10 in FIG. 7. Plants 60 may also be placed in double receiving openings 30 formed by a pair of adjacent universal blocks 20 each having a panel 22A-22D removed from an adjacent wall 21A-21D having one of the universal blocks 20 inverted relative to the adjacent universal block 20 to join the two receiving openings 30 together to form a double receiving opening 30, as shown on the right side of the column 10 in FIG. 7.

Alternately, fountains (not shown) may be formed by variously stacked and arrayed blocks 20 with water flowing down through the aligned interior openings 25 and 26 and out the various side wall openings 30. Another alternate use of the universal blocks 20 is to place them in an array to create a retaining wall (not shown). Plants 60 or lights 50 may be placed in the openings 30 in one or more blocks 20 in the retaining wall.

The universal blocks 20 may also be used as a base (not shown) to laminate finished rock, tile, or other outer surface finishes onto the base array of blocks 20.

The blocks 20 may be manufactured in any of a variety of colors and may be used for decorative effects or to match existing structures or landscape

It is understood that the preceding description is given merely by way of illustration and not in limitation of the invention and that various modifications may be made thereto without departing from the spirit of the invention as claimed.

What is claimed is:

1. A universal block system having knockout panels to form receiving openings in each universal block to be used in structural and landscaping arrays with external elements inserted in the receiving openings, the system comprising:
a series of universal blocks, each universal block comprising a configuration of interconnected walls forming a continuous perimeter around a hollow center, the interconnected walls having a continuous shared top edge defining a top opening and a continuous shared bottom edge defining a bottom opening, a top edge of one universal block mating with and aligning with a bottom edge of an adjacent universal block in an array; at least one knockout panel cast into each of the walls extending from an edge of the wall to a tapered portion on an interior face of the wall, each knockout panel comprising an internally recessed wall portion of the wall and a recessed cutting slot on each side of the internally recessed wall portion for cutting through the wall in the recessed cutting slots to remove the knockout panel leaving an receiving opening in the wall having finished edges extending transversely through the wall along a portion of the height of the wall for inserting any of a variety of desired items within the receiving opening, thereby forming a universal block having walls with recessed side panels with cut out lines formed in the block on the sides for cutting out as many side panels as desired to form receiving openings in the block to be used in structural and landscaping arrays with external elements inserted in the receiving openings.

2. The system of claim 1 wherein each of the universal blocks has four flat orthogonal walls and flat edges perpendicular to the walls so that the universal blocks are stackable in any desired array.

3. The system of claim 2 wherein a pair of adjacent universal blocks each having a panel removed from an adjacent wall having one of the universal blocks inverted relative to the adjacent universal block to join the two receiving openings together to form a double size receiving opening.

4. The system of claim 2 wherein the universal blocks are stacked in a series of spaced vertical arrays and at least one of the panels is removed from at least one universal block to form at least one receiving opening in a first vertical array to align with at least one mating aligned receiving opening in a second vertical array to receive a horizontal fence rail therebetween in the receiving openings so that the spaced vertical arrays of universal blocks form fence posts.

5. The system of claim 4 wherein a pair of adjacent universal blocks each having a panel removed from an adjacent wall having one of the universal blocks inverted relative to the adjacent universal block to join the two receiving openings together to form a double size receiving opening for receiving a wide fence rail through the double size receiving openings.

6. The system of claim 4 wherein at least one of the vertically stacked arrays of the universal blocks comprises a corner fence post having two adjacent cut out panels of one of the universal blocks cut out to form receiving openings for two orthogonal fence rails inserted with one in each of the receiving openings.

7. The system of claim 2 wherein at least one of the universal blocks in an array of universal blocks has at least one panel removed to for a receiving opening for inserting a light source therein.

8. The system of claim 7 further comprising a translucent glass block inserted in the receiving opening for admitting light out of the receiving opening through the glass block.

9. The system of claim 7 wherein the universal blocks are assembled in a vertical array to form a light post.

10. The system of claim 7 wherein the universal blocks are assembled in a horizontal array to line a travel way and a number of the universal blocks have receiving openings with light sources therein for illuminating the travel way.

11. The system of claim 2 comprising a vertically stacked array of the universal blocks of the present invention to form a column planter with a plant in the top opening of the top block and a plurality of plants down the column in single receiving openings in a number of the universal blocks and in double receiving openings formed by a pair of adjacent universal blocks each having a panel removed from an adjacent wall having one of the universal blocks inverted relative to the adjacent universal block to join the two receiving openings together to form a double receiving opening.

12. The system of claim 2 further comprising a cap over a top universal block in an array.

13. The system of claim 1 wherein the universal block comprises a cast masonry block and a smooth edged receiving opening is formed in each panel cut out with a masonry saw along the recessed cutting slots on one or all sides of an array of blocks produced by using a masonry saw blade in the preset cutting lines to remove as many of the knock out panels as desired.
